(19) United States
(12) Patent Application Publication
(10) Pub. No.: US 2018/0170712 A1
(43) Pub. Date: Jun. 21, 2018

(54) FOLDABLE GUIDE RAIL TRACKS FOR ELEVATOR SYSTEMS

(71) Applicant: Otis Elevator Company, Famington, CT (US)

(72) Inventor: Aurelien Fauconnet, Isdes (FR)

(21) Appl. No.: 15/831,640

(22) Filed: Dec. 5, 2017

(30) Foreign Application Priority Data
Dec. 20, 2016 (EP) 16290241.5

(51) Int. Cl. B66B 7/02

(52) U.S. Cl. CPC B66B 7/026; B66B 7/025

(57) ABSTRACT

Foldable guide rail tracks in elevator systems having first and second rail sections each having a base and a blade and a rail connector rotatably connecting the first rail section and the second rail section. The rail connector has a first securing plate fixedly attached to the first rail section, a second securing plate fixedly attached to the second rail section, and a pivot rotatably connecting the first securing plate to the second securing plate. The first rail section is rotatable about the pivot relative to the second rail section from a folded state to an unfolded state, and, when in the unfolded state, the first base and first blade of the first rail section aligns with the second base and second blade of the second rail section to form at least a portion of a guide rail track.

### CROSS-REFERENCE TO RELATED APPLICATIONS

This application claims the benefit of European Application No. 16290241.5 filed on Dec. 20, 2016, which is incorporated herein by reference in its entirety.

### BACKGROUND

The subject matter disclosed herein generally relates to elevator systems and, more particularly, to foldable guide rail tracks.

Current elevator systems use one type of guide rail to form a guide rail upon which an elevator car and/or counterweight may travel. Installation of guide rails can be a time consuming and labor intensive process. For example, long sections of guide rail track may require multiple installers or mechanics to properly install within an elevator shaft. Accordingly, improved installation techniques for elevator guide rail tracks may be desirable.

### SUMMARY

According to some embodiments, foldable guide rail tracks for elevator systems are provided. The foldable guide rail tracks include a first rail section having a first base and a first blade, a second rail section having a second base and a second blade, and a rail connector rotatably connecting the first rail section and the second rail section. The rail connector includes a first securing plate fixedly attached to the first rail section, a second securing plate fixedly attached to the second rail section, and a pivot rotatably connecting the first securing plate to the second securing plate. The first rail section is rotatable about the pivot relative to the second rail section from a folded state to an unfolded state, and, when in the unfolded state, the first base and first blade of the first rail section aligns with the second base and second blade of the second rail section to form at least a portion of a guide rail track.

In addition to one or more of the features described herein, or as an alternative, further embodiments of the foldable guide rail track may include a first stop plate attached to the first securing plate and a second stop plate attached to the second securing plate, wherein the first stop plate contacts the second securing plate and the second stop plate contacts the first securing plate in the unfolded state.

In addition to one or more of the features described herein, or as an alternative, further embodiments of the foldable guide rail track may include that the first stop plate is located between the first securing plate and the base of the first rail section and the second securing plate is located between the second stop plate and the base of the second rail section.

In addition to one or more of the features described herein, or as an alternative, further embodiments of the foldable guide rail track may include that at least one of (i) the first stop plate and the first securing plate or (ii) the second stop plate and the second securing plate are integrally formed.

In addition to one or more of the features described herein, or as an alternative, further embodiments of the foldable guide rail track may include a plurality of fasteners fixedly attaching the first securing plate to the base of the first rail section and fixedly attaching the second securing plate to the base of the second rail section.

In addition to one or more of the features described herein, or as an alternative, further embodiments of the foldable guide rail track may include a plurality of securing fasteners fixedly attaching the first and second securing plates to the base of the first rail section and the base of the second rail section when in the unfolded state.

In addition to one or more of the features described herein, or as an alternative, further embodiments of the foldable guide rail track may include at least one first alignment feature on the first rail section and at least one second alignment feature on the second rail section, wherein the first and second alignment features align the first and second rail sections during transition from the folded state to the unfolded state.

In addition to one or more of the features described herein, or as an alternative, further embodiments of the foldable guide rail track may include that the at least one first alignment feature is a rib formed on an end of the first rail section and the at least one second alignment feature is a channel formed in an end of the second rail section, wherein the channel receives the rib when in the unfolded state.

In addition to one or more of the features described herein, or as an alternative, further embodiments of the foldable guide rail track may include a third rail section rotatably connected to the second rail section by a second rail connector.

In addition to one or more of the features described herein, or as an alternative, further embodiments of the foldable guide rail track may include that the first rail section and the second rail section are of the same length.

In addition to one or more of the features described herein, or as an alternative, further embodiments of the foldable guide rail track may include that the first securing plate includes a plurality of securing apertures, the second securing plate includes a plurality of securing apertures, the first rail section includes at least one first rail aperture, the second rail section includes at least one first rail aperture and, when in the unfolded state, at least one of the plurality of securing apertures of the first and second securing plates aligns with the at least one rail aperture of the first rail section and at least one of the plurality of securing apertures of the first and second securing plates aligns with the at least one rail aperture of the second rail section.

Technical effects of embodiments of the present disclosure include foldable guide rail tracks that enable ease of installation within elevator shafts. Further technical effects include rail connectors that connect rail sections that enable folding of the guide rail for transportation and ease of installation.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic illustration of an elevator system that may employ various embodiments of the disclosure;

FIG. 1B is a side schematic illustration of an elevator car of FIG. 1A attached to a guide rail track;

FIG. 2A is a schematic illustration of a foldable guide rail in accordance with a non-limiting embodiment of the present disclosure;

FIG. 2B is a rear side schematic illustration of a rail connector connecting two rail sections of the foldable guide rail shown in FIG. 2A, illustrated in a folded state;

FIG. 2C is a front side schematic illustration of the configuration shown in FIG. 2B;

FIG. 2D is a rear side schematic illustration of an intermediate state during unfolding of the foldable guide rail of FIG. 2A;

FIG. 2E is a front side schematic illustration of the intermediate state during unfolding of the foldable guide rail of FIG. 2A;

FIG. 2F is a rear side schematic illustration of the rail connector and rail sections in an unfolded state;

FIG. 2G is a front side schematic illustration of the rail connector and rail sections not secured in the unfolded state;

FIG. 2H is a rear side schematic illustration of the rail connector and rail sections not secured in the unfolded state and secured together;

FIG. 2I is a front side schematic illustration of the rail connector and rail sections in the unfolded state and secured together;

FIG. 2J is a side elevation schematic illustration of the rail connector and rail sections in the unfolded state and secured together; and

FIG. 2K is a front side elevation schematic illustration of the rail connector and rail sections in the unfolded state and secured together.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

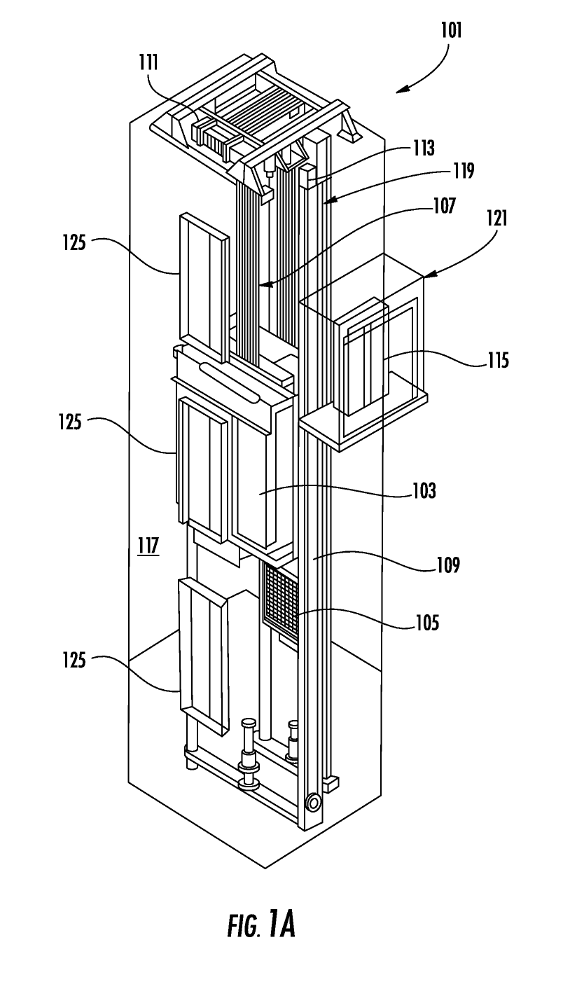

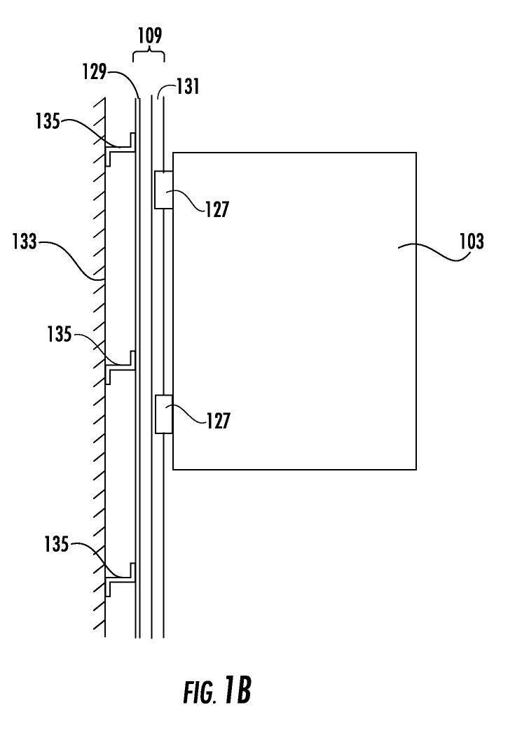

FIG. 1A is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1A is merely a non-limiting example presented for illustrative and explanatory purposes.

FIG. 1B is a side view schematic illustration of the elevator car 103 as operably connected to the guide rail 109. As shown, the elevator car 103 connects to the guide rail 109 by one or more guiding devices 127. The guiding devices 127 may be guide shoes, rollers, etc., as will be appreciated by those of skill in the art. The guide rail 109 defines a guide rail track that has a base 129 and a blade 131 extending therefrom. The guiding devices 127 of the elevator car 103 are configured to run along and/or engage with the blade 131 of the guide rail 109. The guide rail 109 mounts to a wall 133 of the elevator shaft 117 (shown in FIG. 1A) by one or more brackets 135. The brackets 135 are configured to fixedly mount to the wall 133, such as by bolts, fasteners, etc. as known in the art. The base 129 of the guide rail 109 fixedly attaches to the brackets 135, and thus the guide rail 109 can be fixedly and securely mounted to the wall 133. As will be appreciated by those of skill in the art, a guide rail of a counterweight of an elevator system may be similarly configured.

Installation of the guide rail 109 within the elevator shaft 117 and to the wall 133 can be a labor intensive operation that takes a significant amount of time and labor. In view of this, guide rails having improved installation features are provided in accordance with the present disclosure.

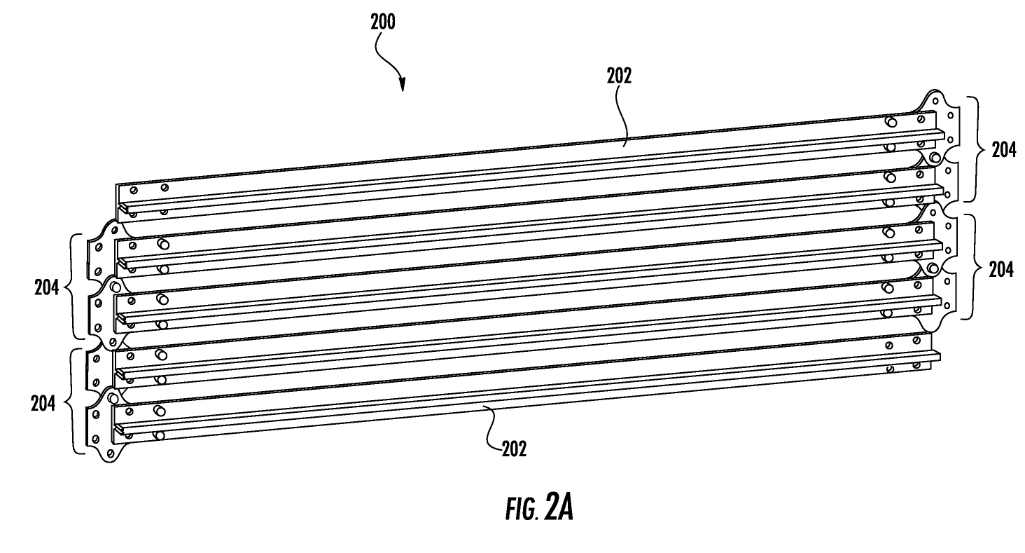

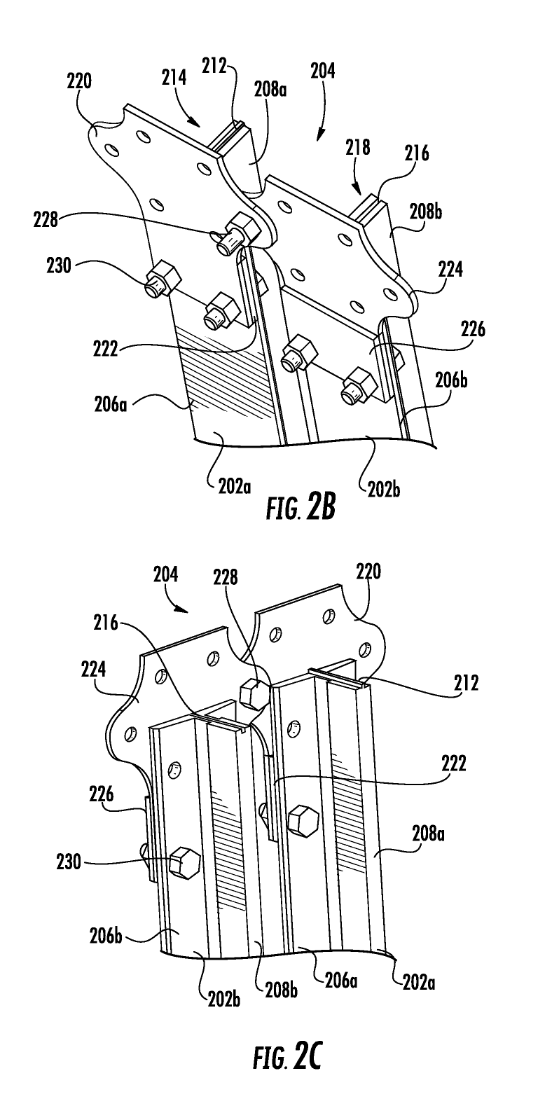

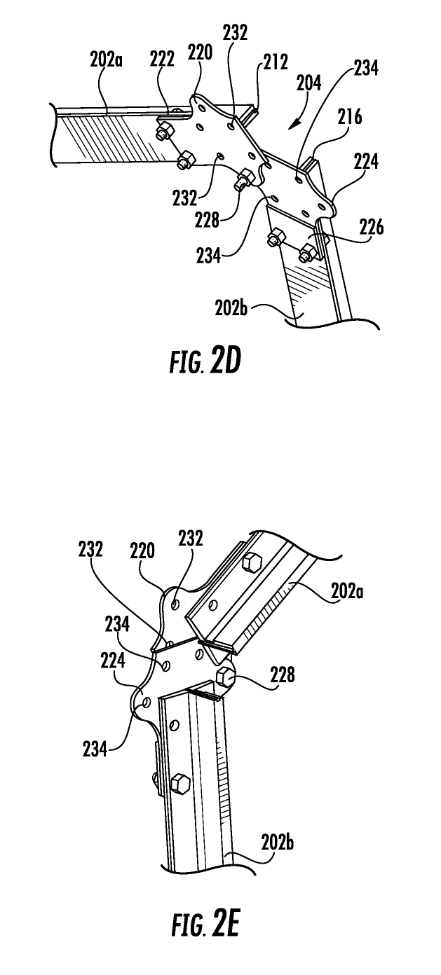

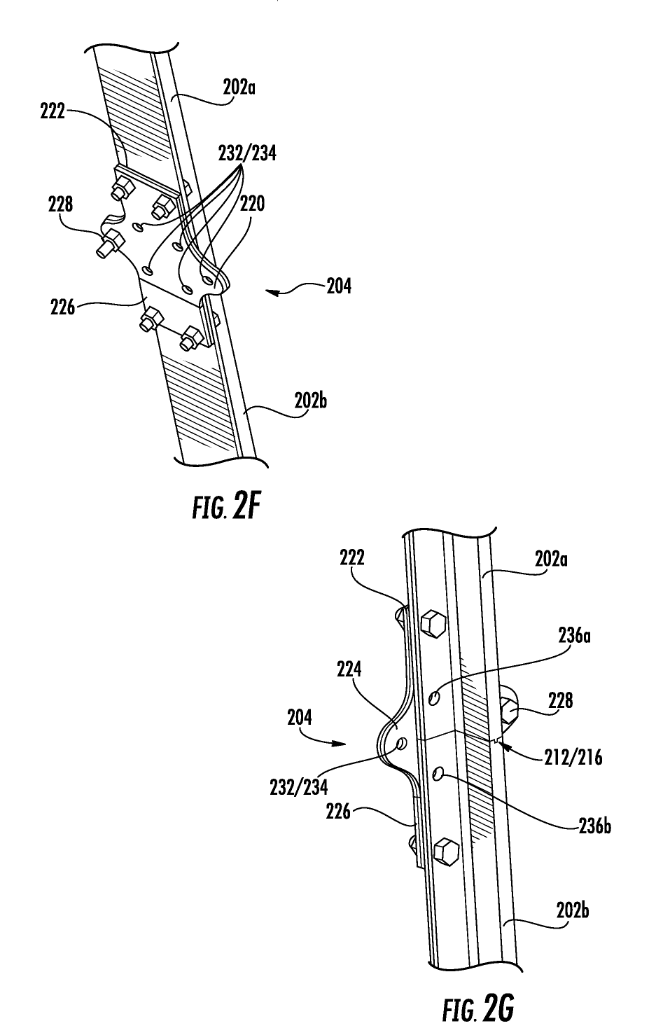

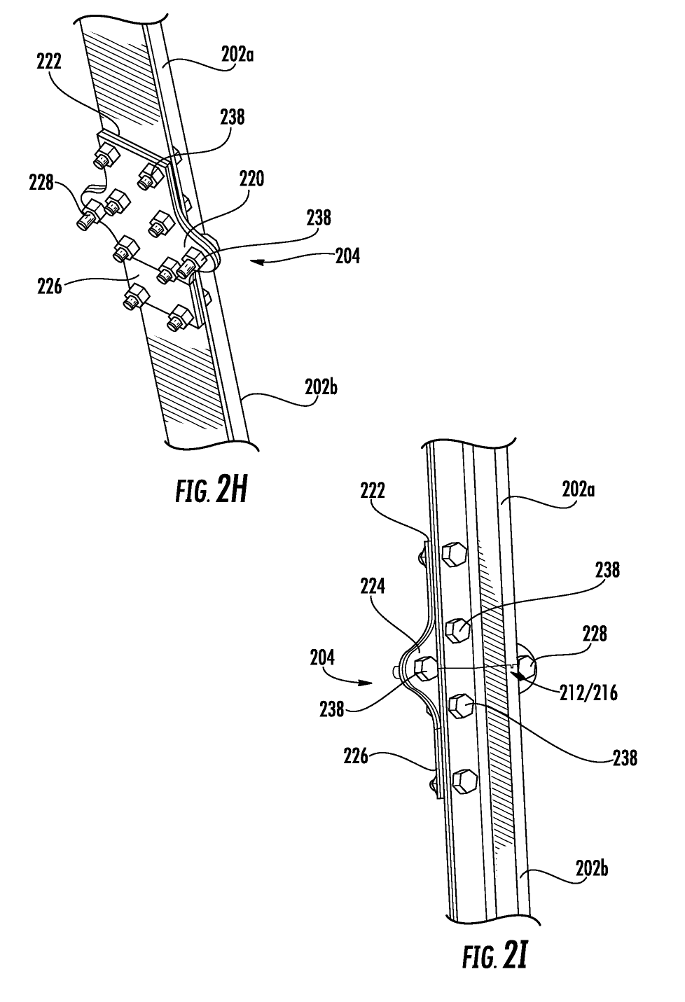

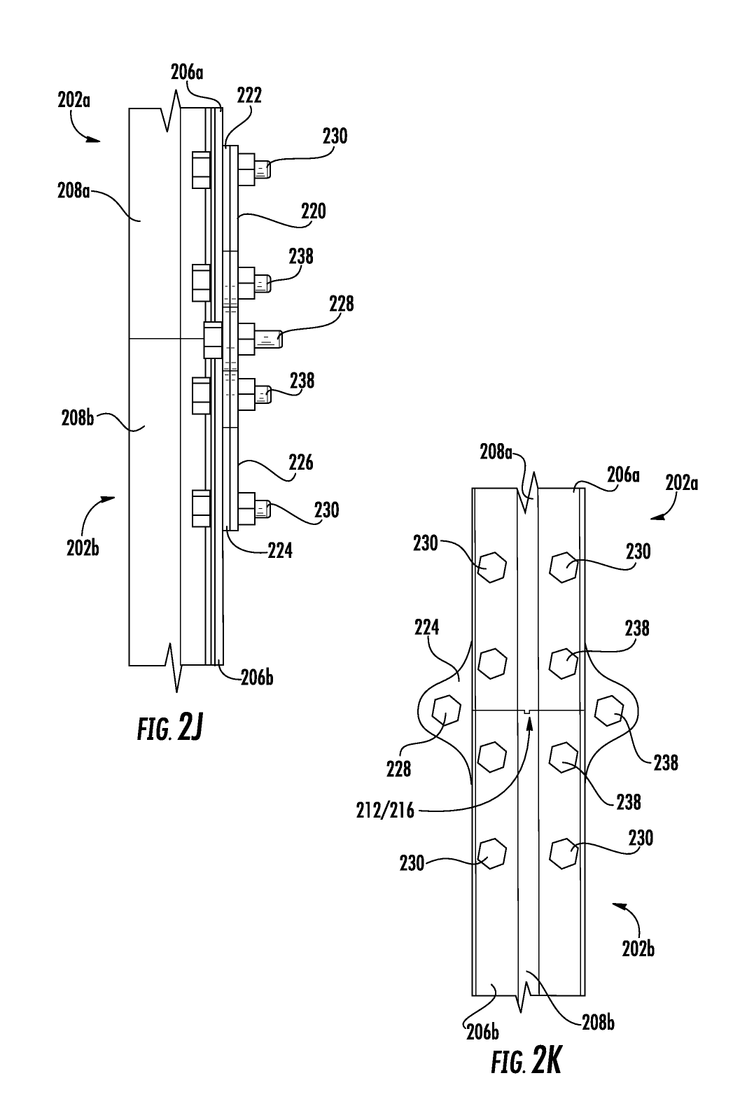

With reference to FIGS. 2A-2K, various schematic illustrations of a guide rail in accordance with a non-limiting embodiment of the present disclosure are shown. FIG. 2A is a schematic illustration of a guide rail 200 having a plurality of rail sections 202 joined by a plurality of rail connectors 204. The guide rail 200 is foldable such that the rail sections 202 can be stacked as shown in FIG. 2A. The rail connectors 204 are configured to enable rotation of adjacent rail sections 202 relative to each other. FIG. 2A illustrates the guide rail 200 in a folded or stowed state.

FIGS. 2B-2K schematically illustrate movement and operation of a rail connector 204 that connects a first rail section 202a and a second rail section 202b. FIG. 2B is a rear view, isometric illustration of the rail connector 204 and the rails sections 202a, 202b in the folded state. FIG. 2C is a front view, isometric illustration of the illustration shown in FIG. 2B. FIGS. 2D-2E are rear and front isometric illustrations of the rail connector 204 and the rails sections 202a, 202b illustrating an intermediate state as the rail sections 202a, 202b are rotated into an unfolded state from the folded state, respectively. FIGS. 2F-2G are rear and front isometric illustrations of the rail connector 204 and the rails sections 202a, 202b illustrating the unfolded state, respectively, prior to securing the rail sections 202a, 202b together. FIGS. 2H-2I are rear and front isometric illustrations of the rail connector 204 and the rails sections 202a, 202b illustrating the unfolded state, respectively, secured together. FIG. 2J is a side view schematic illustration of the rail connector 204 and the rails sections 202a, 202b in the unfolded state and FIG. 2K is a front schematic illustration of rail connector 204 and the rails sections 202a, 202b in the unfolded state.

As shown in FIGS. 2B-2C, the first and second rail sections 202a, 202b include respective bases 206a, 206b and respective blades 208a, 208b. The first rail section 202a includes a first alignment feature 212 formed on an end 214 of the first rail section 202a. Similarly, the second rail section 202b includes a second alignment feature 216 formed on an end 218 of the second rail section 202b. The first and second alignment features 212, 216 are optional and can have various structural configurations. For example, as shown in FIGS. 2B-2C, the first alignment feature 212 is a rib or protrusion and the second alignment feature 216 is a channel or depression that is shaped to receive the first alignment feature 212. Other types of alignment features can be used without departing from the scope of the present disclosure, including, but not limited to, pegs-and-holes, key-and-slot, curved, geometric, and/or contoured surfaces, etc. The alignment features 212, 216 are provided to aid in aligning the first and second rail sections 202a, 202b when rotating from the folded state to the unfolded state for installation within an elevator shaft. Although shown with the alignment features 212, 216 spanning both the respective bases and blades, in other embodiments, alignment features may be formed on only the base or only the blade, and thus various alternative configurations are contemplated without departing from the scope of the present disclosure.

The rail connector 204 is fixedly attached to both the first rail section 202a and the second rail section 202b proximate the ends 214, 218. The rail connector 204 includes a first securing plate 220 and a first stop plate 222 fixedly connected to the first rail section 202a and a second securing plate 224 and a second stop plate 226 fixedly connected to the second rail section 202b. The first and second securing plates 220, 224 are rotatably connected about a pivot 228. The first and second securing plates 220, 224 and the first and second stop plates 222, 226 are fixedly connected to the first and second rail sections 202a, 202b, respectively, by fasteners 230.

In some embodiments, such as shown in FIGS. 2B-2K, the securing plates 220, 224 and the stop plates 222, 226 are separate plates that are held together, in part, by one or more fasteners 230. However, in other embodiments, the securing plates and stop plates can be welded together, integrally formed, or otherwise attached or connected. The securing plates 220, 224 are rotatable about the pivot 228 from a folded state (e.g., FIGS. 2B-2C) to an unfolded state (e.g., FIGS. 2F-2G). The securing plates 220, 224 enable the first and second rail sections 202a, 202b to be secured to each other in the unfolded state to form a guide rail that can be installed to a wall of an elevator shaft, e.g., as shown in FIG. 1B.

Further, in some embodiments, such as shown in FIGS. 2B-2K, the pivot 228 can be a fastener that fixedly and rotatably connects the first securing plate 220 to the second securing plate 224. However, those of skill in the art will appreciate that the pivot 228 can take other forms, such as a pin, axle, or shaft configuration. In other embodiments, the pivot can be formed as a bearing, a hinge, or other structures.

As noted above, FIGS. 2B-2C illustrate two rail sections 202a, 202b in a folded state (e.g., as shown in FIG. 2A). The rail sections 202 of FIG. 2A can be expanded to form a complete and continuous guide rail that is installed into an elevator shaft of an elevator system. The guide rail 200 shown in FIG. 2A is folded such that it can be easily moved into and positioned within an elevator shaft. The guide rail 200 can then be extended with each rail section 202 connected by rail connectors 204 and rotating relative to adjacent rail sections 200 by the rail connectors 204.

For example, as shown in FIG. 2D-2E, the first rail section 202a is in a rotated state relative to the second rail section 202b, as the rail sections 202a, 202b are rotated from a folded state toward an unfolded state. As shown, the first rail section 202a and the first securing plate 220 are rotated about the pivot 228 relative to the second rail section 202b and the second securing plate 224. As the two rail sections 202a, 202b are rotated into the unfolded state, the first securing plate 220 will contact the second stop plate 226 and the second securing plate 224 will contact the first stop plate 222. Further, the alignment features 212, 216 will engage with each other.

For example, in FIGS. 2F-2G, rear and front isometric illustrations of the rail connector 204 and the first and second rail sections 202a, 202b in the unfolded state are shown. As shown, in the unfolded state, the first securing plate 220 abuts and contacts the second stop plate 226 and the second securing plate 224 abuts and contacts the first stop plate 222. Further, the alignment features 212, 216 engage to align the first and second rail sections 202a, 202b.

As shown in FIGS. 2F-2G, the first and second securing plates 220, 224 include securing apertures 232, 234, respectively (also shown in FIGS. 2D-2E). The securing apertures 232, 234 are aligned when the first and second securing plates 220, 224 are rotated into the unfolded state. As shown in FIG. 2G, the rail sections 202a, 202b also include rail apertures 236a, 236b that align with the securing apertures 232, 234 to enable securing of the securing plates 220, 224 to the rail sections 202a, 202b and thus form a secured and stable guide rail for operation with an elevator system.

As shown in FIGS. 2H-2K, a plurality of securing fasteners 238 are inserted through the securing apertures 232, 234 and rail apertures 236a, 236b to secure the rail sections 202a, 202b in the unfolded state. As shown, the bases 206a, 206b and the blades 208a, 208b of the rail sections 202a, 202b align to form a continuous section of guide rail. The rail sections 202a, 202b are fixedly secured such that an elevator car can move along the guide rail 200. That is, when in the unfolded state, the guide rail 200 forms a guide rail track for supporting and guiding movement of an elevator car with in an elevator shaft.

As shown in FIG. 2J, the first stop plate 222 is positioned and secured between the first securing plate 220 and the base 206a of the first rail section 202a. In contrast, the second securing plate 224 is positioned and secured between the second stop plate 226 and the base 206b of the second rail section 202b. Due to this configuration, when rotated into the unfolded state, a portion of the first securing plate 220 contacts and abuts the second stop plate 226 and a portion of the second securing plate 224 contacts and abuts the first stop plate 222. As will be appreciated, the thickness of the stop plates 222, 226 and the securing plates 220, 224 can be the same such that a flush engagement is achieved. Accordingly, the first stop plate 222 may operate as a shim or offset for the first securing plate 220 such that the second securing plate 224 can be moved into position between the first securing plate 220 and the bases 206a, 206b of the first and second rail sections 202a, 202b, as shown in FIG. 2J.

Advantageously, embodiments of the present disclosure provide a foldable guide rail track. Accordingly, a compact and easily maneuverable and installable guide rail track is provided. In some configurations, each rail section of the foldable guide rail track can have a length that enables the folded guide rail to be delivered in the folded or folded state into a pit of an elevator shaft. As such, the folded guide rail track in accordance with embodiments provided herein can be very compact. For example, in one non-limiting configuration, the folded guide rail can have dimensions of about 2 m×0.6 m×0.1 m (about 6.5 ft.×2 ft.×0.3 ft.) for a guide rail track of 10 m (32 ft.) when expanded or unfolded and installed. With such small dimensions in the folded state, the folded guide rail can be delivered directly into the pit of the elevator shaft, for example, using a fork lift and a hoist. Once in the pit of the elevator shaft, a mechanic can use a hoist to lift and unfold the foldable guide rail track. For example, the hoist can be attached to a first or top rail section of the foldable guide rail and the first or top rail section is lifted, by a free end. As the first rail section is lifted by the free end, the second or next rail section will also be lifted through the connection between the first and second rail sections achieved by the rail connector in accordance with the present disclosure. Thus, the foldable guide rail track can be extended into an unfolded state to form a continuous guide rail track that extends within an elevator shaft. Once extended, the mechanic can fixedly connect or attach each of the rail sections at the rail connectors using various fastening mechanism, such as screws or bolts, to fix and secure the rotation of each of the securing plates of the rail connectors.

Advantageously, embodiments provided herein enable a compact and foldable guide rail track to be easily transported and installed within an elevator shaft. Such compact and foldable guide rail tracks can eliminate long sections of guide rail tracks. Further, such compact and foldable guide rail tracks enable ease of installation (e.g., reduction in number of required installers/mechanics, reduction in installation time, etc.).

Further, advantageously, foldable guide rail tracks as provided herein can enable pre-assembly performed at a factory. For example, any number of rail sections can be attached by rail connectors in accordance with the present disclosure such that any desired length of installed guide rail track can be achieved. Further, in some embodiments, each rail section can be of a different length, which can provide additional customizability to the foldable guide rail track in accordance with the present disclosure.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

What is claimed is:

1. A foldable guide rail track for an elevator system comprising:
a first rail section having a first base and a first blade;
a second rail section having a second base and a second blade; and
a rail connector rotatably connecting the first rail section and the second rail section, the rail connector comprising:
a first securing plate fixedly attached to the first rail section;
a second securing plate fixedly attached to the second rail section; and
a pivot rotatably connecting the first securing plate to the second securing plate,
wherein the first rail section is rotatable about the pivot relative to the second rail section from a folded state to an unfolded state, and
wherein, when in the unfolded state, the first base and first blade of the first rail section aligns with the second base and second blade of the second rail section to form at least a portion of a guide rail track.

2. The foldable guide rail track of claim 1, further comprising a first stop plate attached to the first securing plate and a second stop plate attached to the second securing plate, wherein the first stop plate contacts the second securing plate and the second stop plate contacts the first securing plate in the unfolded state.

3. The foldable guide rail track of claim 2, wherein the first stop plate is located between the first securing plate and the base of the first rail section and the second securing plate is located between the second stop plate and the base of the second rail section.

4. The foldable guide rail track of claim 2, wherein at least one of (i) the first stop plate and the first securing plate or (ii) the second stop plate and the second securing plate are integrally formed.

5. The foldable guide rail track of claim 1, further comprising a plurality of fasteners fixedly attaching the first securing plate to the base of the first rail section and fixedly attaching the second securing plate to the base of the second rail section.

6. The foldable guide rail track of claim 1, further comprising a plurality of securing fasteners fixedly attaching the first and second securing plates to the base of the first rail section and the base of the second rail section when in the unfolded state.

7. The foldable guide rail track of claim 1, further comprising at least one first alignment feature on the first rail section and at least one second alignment feature on the second rail section, wherein the first and second alignment features align the first and second rail sections during transition from the folded state to the unfolded state.

8. The foldable guide rail track of claim 7, wherein the at least one first alignment feature is a rib formed on an end of the first rail section and the at least one second alignment feature is a channel formed in an end of the second rail section, wherein the channel receives the rib when in the unfolded state.

9. The foldable guide rail track of claim 1, further comprising a third rail section rotatably connected to the second rail section by a second rail connector.

10. The foldable guide rail track of claim 1, wherein the first rail section and the second rail section are of the same length.

11. The foldable guide rail track of claim 1, wherein:
the first securing plate includes a plurality of securing apertures;
the second securing plate includes a plurality of securing apertures;
the first rail section includes at least one first rail aperture;
the second rail section includes at least one first rail aperture; and
when in the unfolded state, at least one of the plurality of securing apertures of the first and second securing plates aligns with the at least one rail aperture of the first rail section and at least one of the plurality of securing apertures of the first and second securing plates aligns with the at least one rail aperture of the second rail section.
